(19) United States
(12) Patent Application Publication
(10) Pub. No.: US 2006/0068254 A1
(43) Pub. Date: Mar. 30, 2006

(54) Electrolyte composition, solid electrolyte membrane and solid polymer fuel cell

(75) Inventors: Makoto Yoshino, Kawasaki (JP); Nawalage Florence Cooray, Kawasaki (JP); Fumio Takei, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/145,213

(22) Filed: Jun. 6, 2005

(30) Foreign Application Priority Data
Sep. 29, 2004 (JP) 2004-283223

(51) Int. Cl. H01M 8/10; C08J 5/20; C08J 5/22; B05D 5/12

(52) U.S. Cl. 429/33; 429/314; 429/316; 429/317; 521/25; 521/27; 427/115

(57) ABSTRACT

A novel electrolyte composition is provided for obtaining a solid electrolyte membrane capable of exhibiting a large ion exchange capacity, high proton conductivity and a low methanol permeation coefficient. This electrolyte composition contains a sulfonic acid group-containing polyimide and having a specific structure. Such a polyimide can be obtained, for example, by reacting 1,4,5,8-naphthalenetetracarboxylic dianhydride with a diamine compound.

### CROSS-REFERENCE TO RELATED APPLICATIONS

This application is based upon and claims the benefit of priority from the prior Japanese Patent Application No. 2004-283223, filed on Sep. 29, 2004, the entire contents of which are incorporated herein by reference.

### FIELD OF THE INVENTION

The present invention relates to a solid electrolyte membrane for a solid polymer fuel cell. More specifically, the present invention relates to a solid electrolyte membrane of a proton-conducting, direct methanol fuel cell (referred to as DMFC, hereafter) or hydrogen fuel cell.

### DESCRIPTION OF THE RELATED ART

Solid electrolyte membranes are important materials which are indispensable for such electrochemical elements as solid polymer fuel cells, temperature sensors, gas sensors, electrochromic devices and the like. Of these uses, solid polymer fuel cells are expected to be one of the features of the future new energy technology. When used in fuel cells, solid electrolyte membranes are often called proton-conducting membranes because they serve the purpose of proton conduction.

Solid polymer fuel cells have a higher output density than other fuel cells, and are capable of operating at low temperatures. At present, research is being directed at applications in which smallness and lightness and rapid load response are required, such as drive sources for automobiles, household generators, power sources for portable devices and the like.

Of these, there is a strong demand for long-lasting drives for such portable devices as portable notebook computers, digital cameras, camera-body VTRs and the like, and portable phone manufacturers are also setting their sights on fuel cells.

Of the solid polymer fuel cells, fuel cells using methanol are a focus of particular interest. Methanol fuel cells are classified into two types: reforming-type cells for which methanol is converted into a gas mainly composed of hydrogen, using a reformer; and DMFC's that directly use methanol without using a reformer. Among them, practical application of the DMFC's to portable devices in the electric/electronic field is highly expected, since no reformer is necessary, and light-weight devices are possible.

Organic polymer materials having sulfonic acid groups, carboxylic groups, phosphoric groups and the like are used for the solid electrolyte membrane which is a vital element of the fuel cell. Conventionally, perfluorosulfonic acid polymers such as Dupont Nafion® membrane and Dow Chemical's Dow membrane have been known as such organic polymer materials.

However, the problem is that although the aforementioned perfluorosulfonic acid polymers have excellent proton conductivity and function adequately as membranes for fuel cells which use hydrogen as the fuel, when they are used as solid electrolyte membranes of DMFCs, there is a strong tendency for the methanol which has a high affinity for water, to permeate from the anode side to the cathode side (crossover).

When crossover occurs, the supplied fuel (methanol) and oxidizer (oxygen at the cathode) react directly, and that part of the methanol is unable to output energy as electricity. Consequently, it is difficult to adequately raise the concentration of the aqueous methanol solution which fills the fuel electrode, limiting the ability to increase output. Since the driving time of a portable device could be increased if the concentration of the methanol fuel could be increased, there is demand for development of novel electrolyte membrane materials capable of providing resistance to methanol crossover.

As materials capable of interrupting methanol crossover, attention has focused on sulfonated polyphenylene ethers, polyether ketones, polyether ether ketones, polyphenylenes, polyethersulfones, polybenzimidazoles, polybenzoxazoles, polybenzothiazoles, polyimides and the like which utilize excellent chemical and thermal stability of heat-resistant polymers, engineering plastics. etc. (see, for example, Japanese Patent Application Laid-open No. 2002-201269 (Claims, and paragraph No. 2-4)).

Of these, polyimides containing sulfonic acid groups offer such features as solvent resistance and the ability to form tough, thin membranes. For such reasons, the use of membranes of sulfonic acid group-containing polyimides as polymer solid electrolyte membranes has been proposed (see for example Japanese Patent Application Laid-open No. 2003-64181 (Claims), Japanese Patent Application Laid-open No. 2003-234014 (Claims), Fang, J. et al, Macromolecules 35, 2002, pp. 9022-9028, and Guo, X. et al, Macromolecules 35, 2002, pp. 6707-6713).

### SUMMARY OF THE INVENTION

These previously proposed sulfonic acid group-containing polyimide membranes have a problem that the aromatic diamine component for use lacks a hydrophobic substituent group on the aromatic rings bound to the amine groups to distance water, and accordingly, when the concentration of sulfonic acid groups in the sulfonic acid group-containing polyimide is raised, the membrane of the sulfonic acid group-containing polyimide absorbs a large amount of water and the water is likely to penetrate in the vicinity of the imide groups, so that the imide rings open and the membrane dissolves upon immersion in acidic water. That is, conventional sulfonic acid group-containing polyimide membranes have inadequate water resistance.

To overcome this defect, techniques have been proposed using fluorinated polyimides containing sulfonic acid groups as proton conductive polymer membranes (see for example Japanese Patent Application Laid-open No. 2004-83864 (Claims)). An extremely wide range of description was made for the general formulae of the aromatic tetracarboxylic acids used to prepare such fluorinated polyimides containing sulfonic acid groups, but there has been no specific description of a sulfonic acid group-containing polyimide prepared from 1,4,5,8-naphthalenetetracarboxylic dianhydride.

It is an object of the present invention to provide a novel electrolyte composition for a solid electrolyte membrane with high proton conductivity, low methanol crossover and excellent water resistance, a solid electrolyte membrane comprising this electrolyte composition, and a solid polymer fuel cell using this solid electrolyte membrane. Other objects and advantages of the present invention will be made clear from the following explanation.

In one aspect of the present invention, an electrolyte composition is provided which contains a sulfonic acid group-containing polyimide having a structural unit represented by Formula 1, 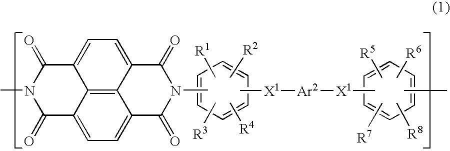
{in Formula 1, at least one of R¹ through R⁸ is F or a perfluoroalkyl group, while the others are each a hydrogen atom or, independently from each other, an alkyl group having 1 to 3 carbon atoms; X¹ is a direct bond, O, S, (CH₂)ₘ or (CF₂)ₘ (where m is, independently from each other, an integer between 1 and 3); and Ar² is a structural unit represented by Formula 2, 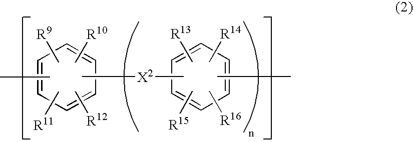
(in Formula 2, X² is a direct bond, O, SO₂, C(CF₃)₂, C(CH₃)₂ or C═O; at least one of R⁹ through R¹⁶ is SO₃Y (where Y is a hydrogen atom or alkali metal), and the others are, independently from each other, F, hydrogen, perfluoroalkyl group having 1 to 3, or an alkyl group having 1 to 3 carbon atoms; and n is an integer between 0 and 2.)}

In this aspect of the present invention, a novel highly water-resistant electrolyte composition can be obtained capable of providing a solid electrolyte membrane having a large ion exchange capacity, high proton conductivity and a low methanol permeation coefficient.

It is desirable that this sulfonic acid group-containing polyimide have a structural unit represented by Formula 1 and a structural unit represented by Formula 3, 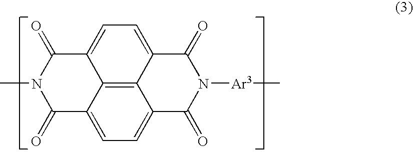
(in Formula 3, Ar³ is a divalent group with no sulfonic acid groups, and having an aromatic ring which may be heterocyclic); that this aromatic ring has a total of 5 to 10 atoms as constituent atoms of the ring; that the proportion of the structural unit represented by Formula 1 in the total of the structural unit represented by Formula 1 and the structural unit represented by Formula 3 be in the range of 5 to 100 mol %; that this sulfonic acid group-containing polyimide be a homopolymer, random copolymer, block copolymer or a mixture of these; that the structural unit represented by Formula 1 be obtained by a reaction of 1,4,5,8-naphthalenetetracarboxylic dianhydride with a diamine compound represented by Formula 4, 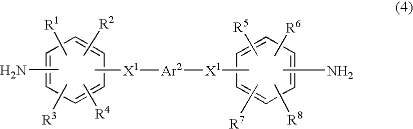
(in Formula, 4 the symbols have the same meaning as in Formula 1); that the diamine compound represented by Formula 4 be a compound represented by Formula 5; 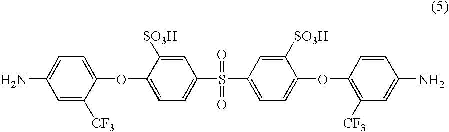
that the structural unit represented by Formula 3 be obtained by a reaction of 1,4,5,8-naphthalenetetracarboxylic dianhydride with a diamine compound with no sulfonic acid groups, and having an aromatic ring which may be heterocyclic; and that the number average molecular weight Mn of this sulfonic acid group-containing polyimide be in the range of 5,000 to 10,000,000.

In another aspect of the present invention, a solid electrolyte membrane comprising the aforementioned electrolyte composition and a solid polymer fuel cell using this solid electrolyte membrane are provided.

In yet another aspect of the present invention, a method is provided for manufacturing a solid electrolyte membrane wherein the aforementioned electrolyte composition contains an organic solvent, the electrolyte composition containing the organic solvent is applied to a substrate, and the solvent is then removed, along with a solid polymer fuel cell using a solid electrolyte membrane prepared by this method.

By these various aspects, it is possible to obtain a highly water-resistant solid electrolyte membrane with a large ion exchange capacity, high proton conductivity and a low methanol permeation coefficient, along with a DMFC, reforming-type methanol fuel cell, hydrogen fuel cell or other solid polymer fuel cell using this solid electrolyte membrane.

A novel solid electrolyte membrane is provided by the present invention. This solid electrolyte membrane can be used in DMFCs, reforming-type methanol fuel cells, hydrogen fuel cells and the like. It can be a solid electrolyte membrane which is highly water resistant and hard to be deteriorated in strong acid atmospheres. When used in a DMFC, it can be a solid electrolyte membrane with a large ion exchange capacity, high proton conductivity and a low methanol permeation coefficient. Moreover, an electrolyte composition for obtaining such a solid electrolyte membrane is provided by the present invention.

### DESCRIPTION OF THE PREFERRED EMBODIMENTS

Embodiments of the present invention are explained below using tables, formulae, examples and the like. These tables, formulae, examples and the like and explanations exemplify but do not limit the scope of the present invention. Other embodiments can of course be covered by the scope of the present invention as long as they are in accord with the intent of the present invention.

The electrolyte composition of the present invention contains a polymer having a sulfonic acid group (also called a sulfonic acid group-containing polyimide in this specification; it is to be noted that when remarks are made on containing or not containing a “sulfonic acid group” in the present invention, the phrase “sulfonic acid group” includes cases in which a sulfonic acid group has another element substituted for the hydrogen and is in the form of a salt). This sulfonic acid group-containing polyimide has a structural unit represented by Formula 1 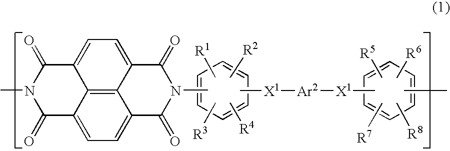
{in Formula 1, at least one of R¹ through R⁸ is F or a perfluoroalkyl group, while the others are each a hydrogen atom or, independently from each other, an alkyl group having 1 to 3 carbon atoms; X¹ is a direct bond, O, S, (CH₂)ₘ or (CF₂)ₘ (where m is, independently from each other, an integer between 1 and 3); and Ar² is a structural unit represented by Formula 2, 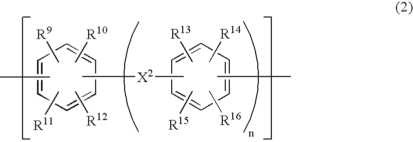
(in Formula 2, X² is a direct bond, O, SO₂, C(CF₃)₂, C(CH₃)₂ or C═O; at least one of R⁹ through R¹⁶ is SO₃Y (where Y is a hydrogen atom or alkali metal) and the others are, independently from each other, F, hydrogen, a perfluoroalkyl group having 1 to 3 carbon atoms or an alkyl group having 1 to 3 carbon atoms; and n is an integer between 0 and 2)}.

When n=0 in Formula 2, SO₃Y is not present at all, but this does not mean that this polyimide is no longer a “sulfonic acid group-containing polyimide.” For example, the requirement of being a “sulfonic acid-group-containing polyimide” can be fulfilled, if this polyimide simultaneously has a structure represented by Formula 2 in which n is 1 or 2, or has another structure containing a sulfonic acid group.

The electrolyte composition of the present invention may also have a structural unit represented by Formula 1 and a structural unit represented by Formula 3, 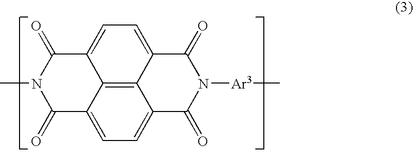
(in Formula 3, Ar³ is a divalent group with no sulfonic acid groups, and having an aromatic ring which may be heterocyclic).

By comprising such a sulfonic acid group-containing polyimide, it is possible to obtain a highly water-resistant novel electrolyte composition which can be made into a solid electrolyte membrane with a large ion exchange capacity, high proton conductivity and a low methanol permeation coefficient.

A solid electrolyte membrane with a large ion exchange capacity, high proton conductivity and a low methanol permeation coefficient is provided by the present invention. This solid electrolyte membrane can be a solid electrolyte membrane which is highly water resistant and hard to be deteriorated in strong acid atmospheres and which can be used in DMFCs, reforming-type methanol fuel cells, hydrogen fuel cells and the like.

The sulfonic acid group-containing polyimide of the present invention is given a fluorine or perfluoroalkyl group in order to improve water resistance. The total of fluorines and perfluoroalkyl groups is preferably 2 to 8 in the structural unit represented by Formula 1.

X¹ and X² are both preferably O. Moreover, the aromatic ring which may be heterocyclic in Ar³ should preferably has a total of 5 to 10 atoms which are constituent atoms of the aromatic ring.

It is desirable from the standpoint of membrane formation capability that the number average molecular weight Mn of the sulfonic acid group-containing polyimide according to the present invention be in the range of 5,000 to 10,000,000. When the sulfonic acid group-containing polyimide according to the present invention is a mixture, Mn is determined with the mixture treated as a single polymer.

Such a polyimide can be prepared by known methods using 1,4,5,8-naphthalenetetracarboxylic dianhydride as the tetracarboxylic acid component, and using a diamine represented by Formula 4 to obtain the polyimide of Formula 1, and using a diamine compound with no sulfonic acid groups, and having an aromatic ring which may be heterocyclic to obtain the polyimide of Formula 3: 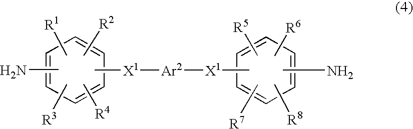
(in Formula 4, the symbols have the same meaning as in Formula 1).

A desirable example of the diamine compound represented by Formula 4 is 4,4′-bis(4-amino-2-trifluoromethylphenoxy)diphenylsulfone-3,3′-disulfonic acid represented by Formula 5, or a sodium salt thereof: 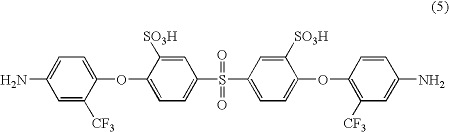
Such a diamine can be prepared by known methods including sulfonation and other reactions using a divalent phenol or an aromatic halide having a nitro group as the starting material.

Examples of divalent phenols which can be used as the starting material for the diamine compound represented by Formula 4 include hydroquinone, resorcinol, 4,4′-biphenol, 2,2′-biphenol, bis(4-hydroxyphenyl)ether, bis(2-hydroxyphenyl)ether, 2,2-bis(4-hydroxyphenyl)propane, 2,2-bis(3-methyl-4-hydroxyphenyl)propane, 2,2-bis(4-hydroxyphenyl)hexafluoropropane, 1,3-bis(4-hydroxyphenoxy)benzene, 1,4-bis(3-hydroxyphenoxy)benzene, bis(2-hydroxy-5-methylphenyl)methane, 1,5-dihydroxynaphthalene, bis(4-hydroxyphenyl)sulfide, bis(4-hydroxyphenyl)sulfone, bis(4-hydroxyphenyl)ketone and the like.

Examples of aromatic halides having nitro groups include 2-fluoro-5-nitrobenzotrifluoride, 5-fluoro-2-nitrobenzotrifluoride, 3,4-difluoronitrobenzene, 2,4-difluoronitrobenzene and the like.

Specific examples of diamine compounds with no sulfonic acid groups, and having an aromatic ring which may be heterocyclic, include 3,4′-oxydianiline, 4,4′-oxydianiline, 3,3′-diaminodiphenylmethane, 3,4′-diaminodiphenylmethane, 4,4′-diaminodiphenylmethane, 3,3′-dimethyl-4,4′-diaminodiphenylmethane, 3,31,5,5′-tetramethyl-4,4′-diaminodiphenylmethane, 2,2′-bis(3-aminophenyl)-hexafluoropropane, 2,2-bis(4-aminophenyl)propane, 2,2-bis(4-aminophenyl)hexafluoropropane, bis-4-(3-aminophenoxy)phenylsulfone and the like,

When both the structural unit represented by Formula 1 and the structural unit represented by Formula 3 are present, the proportion of the structural unit represented by Formula 1 should be 5 mol % or more. Below this range, proton conductivity is inadequate in some cases.

The sulfonic acid group-containing polyimide according to the present invention may be prepared by any method, such as dimerization, oligomerization and polymerization. In this way, if it is a homopolymer, it can be obtained by polymerization, while if it is a block copolymer, it can be obtained, for example, by a redistribution reaction or polymerization reaction of an oligomer obtained by oligomerization or a polymer, with another oligomer or polymer.

The aforementioned sulfonic acid group-containing polyimide may be either a homopolymer composed solely of a structural unit represented by Formula 1, or a random copolymer or a block copolymer of a structural unit represented by Formula 1 and a structural unit represented by Formula 3. It may also be any blend of a homopolymer composed solely of a structural unit represented by Formula 1, a homopolymer consisting of a structural unit represented by Formula 3, a random copolymer composed of a structural unit represented by Formula 1 and a structural unit represented by Formula 3, and a block copolymer composed of a structural unit represented by Formula 1 and a structural unit represented by Formula 3.

A novel electrolyte composition is obtained by the present invention. A highly water-resistant solid electrolyte membrane which resists deterioration in strong acid atmospheres and which can be used in solid polymer fuel cells such as DMFCs, reforming-type methanol fuel cells, hydrogen fuel cells and the like can be obtained from this electrolyte composition. When used in DMFCs, it can become a solid electrolyte membrane with a large ion exchange capacity, high proton conductivity and a low methanol permeation coefficient.

In addition to the aforementioned sulfonic acid group-containing polyimide, other polymers, solvents, catalysts and additives can be included in the electrolyte composition according to the present invention. The other polymers include polyacrylate and polysiloxane, solvents include dimethylacetamide, dimethylformamide, N-methylpyrrolidone, dimethyl sulfoxide and metacresol, and catalysts include benzoic acid.

A solid electrolyte membrane can be prepared from an electrolyte composition according to the present invention obtained in this way. When the electrolyte composition according to the present invention comprises an organic solvent, this electrolyte composition can be applied to a substrate, and the solvent is then removed to easily manufacture a solid electrolyte membrane. This substrate may be any which is inactive with respect to the electrolyte composition and solvent and which is suitable for forming a membrane of an electrolyte composition.

The solid electrolyte membrane obtained in this way can be used in solid polymer fuel cells, particularly DMFCs, reforming-type methanol fuel cells, hydrogen fuel cells and the like. It can be a solid electrolyte membrane which is hard to be deteriorated in strong acid atmospheres. When used in a DMFC, it can be a solid electrolyte membrane which has a large ion exchange capacity, high proton conductivity and a low methanol permeation coefficient.

### EXAMPLES

Examples according to the present invention and comparative examples are explained below. Analysis was performed by the following methods.

(H-NMR)

Measurements were performed with a Nippon Denshi JEOL EX-270, using deuterated dimethyl sulfoxide as the solvent.

(Solution Viscosity)

A polymer sample was dissolved in m-cresol to a weight percentage of 0.5%, and measured at 35° C. using an Ostwald viscometer. The solution viscosity ηsp/c was calculated by the following formula:
ηsp/c=[(t−t₀)/t₀]×(1/c)
(where t is the flow-out time of the solution, t₀ is the flow-out time of the pure solvent and c is the solvent concentration).
(Ion Exchange Capacity)

Ion exchange capacity was measured by the titration method. About 100 mg of a film sample was immersed for 2 days in 50 mL of saturated saline, after which proton ions dissociated from the film sample were titrated with an 0.01 N aqueous sodium hydroxide solution to find the ion exchange capacity.

(Proton Conductivity)

A section with a diameter of 30 mm was cut from a film sample and set on a polytetrafluoroethylene holder, and the film resistance was measured. Measurement was performed in water. The distance between voltage terminals was set to 3, 4, 5 and 6 mm. The temperature was altered by altering the temperature in a thermostatic bath containing a conductivity measurement cell. The measurement temperature range was 5 to 70° C.

(Methanol Permeation Coefficient)

Ion-exchange water and an aqueous solution of 10% methanol by volume were brought into contact with each other at room temperature with a film sample having a diameter of 30 mm therebetween, and changes over time of the methanol concentration in the ion-exchange water side were measured by gas chromatography. The methanol permeation coefficient was calculated from the slope of the resulting methanol concentration increase line.

### Example 1

### Synthesis of 4,4′-bis(4-amino-2-trifluoromethylphenoxy)diphenylsulfone-3,3-disulfonic acid

4,4′-dihydroxydiphenylsulfone (25 g, 100 mmol) was dissolved in sulfuric acid (50 mL, 96% by weight) in a reaction container, and 50 mL of fuming sulfuric acid (SO₃, 30% by weight) was dripped into this mixture. The solution was subjected to reaction for 6 hours at 60° C.

After being cooled, this was poured into ice water. After addition of sodium chloride to saturation, the precipitated solids were filtered and dried. Twenty two g of the resulting solids were dissolved in 100 mL of dimethyl sulfoxide, and after addition of 150 mL of toluene and 4 g of sodium hydroxide dissolved in 10 mL of water, were placed in a Dean-stark trap attached to a cooling condenser, azeotropically distilled with toluene, and agitated for 4 hours as the water was removed.

This was cooled to room temperature and then heated for 20 hours at 150° C. after addition of 2-fluoro-5-nitrobenzotrifluoride (20.9 g, 100 mmol). Next, after cooling to room temperature followed by filtration, the filtrate was distilled under reduced pressure, and the resulting solids were washed with acetone and dried in vacuo.

Eighteen g of the resulting solids were placed in a flask together with 100 mL ethanol, 100 mL water and 2 g palladium/carbon, and 30 mL of hydrazine-hydrate was dripped in, followed by 24 hours' agitation at 95° C. in a flow of nitrogen gas. Next, after cooling to room temperature followed by filtration, the filtrate was dripped into a 5 N aqueous hydrochloric acid solution. The precipitated solids were washed in water and dried.

The product was dissolved in deuterated dimethyl sulfoxide with a small amount of added triethylamine, and measured by H-NMR. Signals based on the H of a benzene ring were observed at 8.30 ppm, 7.82 ppm and 7.42 ppm, and from the assignment and relative integrated intensity it was confirmed that the product was 4,4′-bis(4-amino-2-trifluoromethylphenoxy)diphenylsulfone-3,3′-disulfonic acid with the structure of Formula 5 above.

### Synthesis of a sulfonic acid Group-Containing polyimide

4,4′-bis(4-amino-2-trifluorophenoxy)diphenylsulfone-3,3′-disulfonic acid in an amount of 7.29 g (10 mmol) and 3.3 mL of triethylamine were added to 60 mL of m-cresol, and once it had been confirmed that the 4,4′-bis(4-amino-2-trifluorophenoxy)diphenylsulfone-3,3′-disulfonic acid was completely dissolved, 2.68 g (10 mmol) of 1,4,5,8-naphthalenetetracarboxylic dianhydride and 1.71 g of benzoic acid were added and heated and agitated for 4 hours at 80° C. and 10 hours at 180° C.

After cooling to room temperature, this reacted polyimide solution was poured into a 2 L beaker containing 1 L acetone as the acetone was agitated. After 1 hour of agitation, a fibrous precipitate obtained was suction filtered. This precipitate was poured into a 2 L beaker containing 1 L acetone as the acetone was agitated. After 1 hour of agitation, the precipitate was suction filtered.

The product was dried in vacuo for 10 hours at 80° C. The solution viscosity of the resulting product was 4.2.

The resulting product was dissolved in m-cresol, poured over a glass plate and dried for 3 hours at 130° C. to obtain a triethylamine-type polyimide film. This film was immersed in methanol for 24 hours at room temperature, and immersed in a 0.5 N aqueous sulfuric acid solution for 24 hours to carry out a proton exchange treatment. After being adequately washed in water, the film was heat-treated in vacuo for 10 hours at 150° C.

### Comparative Example 1

A polyimide was synthesized in the same way as in Example 1 except that 2.31 g (6.7 mmol) of 2,2′-benzidinesulfonic acid and 1.45 g (3.35 mmol) of bis-4-(3-aminophenoxy)phenylsulfone were used in place of 4,4′-bis(4-amino-2-trifluorophenoxy)diphenylsulfone-3,3′-disulfonic acid, and a polyimide film was obtained and proton exchanged.

### Comparative Example 2

A polyimide was synthesized in the same way as in Example 1 except that 1.72 g (5 mmol) of 2,2′-benzidinesulfonic acid and 1.00 g (5 mmol) of 4,4′-oxydianiline were used in place of 4,4′-bis(4-amino-2-trifluorophenoxy)diphenylsulfone-3,3′-disulfonic acid, and a polyimide membrane was obtained and proton exchanged.

The analytical results of the ion exchange capacity, proton conductivity and methanol permeation coefficient of the films obtained in Example 1 and Comparative Examples 1 and 2 are shown in Table 1. From the results of Table 1 it is seen that with the present invention, it is possible to provide a sulfonated polyimide polymer solid electrolyte membrane capable of exhibiting a large ion exchange capacity, high proton conductivity and a low methanol permeation coefficient.

TABLE 1

| | Example | Comparative | Comparative |
|---|---|---|---|
| Item | 1 | Example 1 | Example 2 |
| Ion exchange capacity | 2.08 | 2.28 | 1.98 |
| mili-equivalent/g) | | | |
| Proton conductivity (S/cm) | 0.10 | 0.08 | 0.07 |
| Methanol permeation | 0.80 | 1.5 | 1.2 |
| coefficient (×10⁻⁶ cm²/sec) | | | |

What is claimed is:

1. An electrolyte composition comprising a sulfonic acid group-containing polyimide having a structure unit represented by Formula 1: 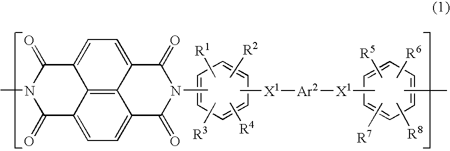
{in Formula 1, at least one of R¹ through R⁸ is F or a perfluoroalkyl group, while the others are each a hydrogen atom or, independently from each other, an alkyl group having 1 to 3 carbon atoms; X¹ is a direct bond, O, S, (CH₂)ₘ or (CF₂)ₘ (where m is, independently from each other, an integer between 1 and 3); and Ar² is a structural unit represented by Formula 2, 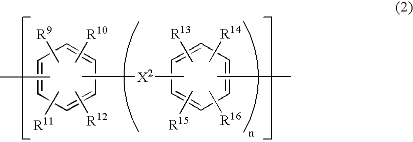
(in Formula 2, X² is a direct bond, O, SO₂, C(CF₃)₂, C(CH₃)₂ or C═O; at least one of R⁹ through R¹⁶ is SO₃Y (where Y is a hydrogen atom or alkali metal) and the others are, independently from each other, F, hydrogen, a perfluoroalkyl group having 1 to 3 carbon atoms or an alkyl group having 1 to 3 carbon atoms; and n is an integer between 0 and 2.)}

2. An electrolyte composition according to claim 1, wherein said sulfonic acid group-containing polyimide has a structural unit represented by Formula 1 and a structural unit represented by Formula 3: 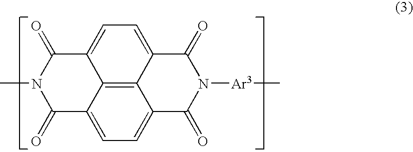
(in Formula 3, Ar³ is a divalent group with no sulfonic acid groups, and having an aromatic ring which may be heterocyclic).

3. An electrolyte composition according to claim 1, wherein said aromatic ring has a total of 5 to 10 atoms as constituent atoms of the aromatic ring.

4. An electrolyte composition according to claim 2, wherein the proportion of the structural unit represented by Formula 1 in the total of the structural unit represented by Formula 1 and the structural unit represented by Formula 3 is in the range of 5 to 100 mol %.

5. An electrolyte composition according to claim 1, wherein said sulfonic acid group-containing polyimide is a homopolymer, random copolymer, block copolymer or a mixture of these.

6. An electrolyte composition according to claim 1, wherein the structural unit represented by Formula 1 is obtained by a reaction of 1,4,5,8-naphthalenetetracarboxylic dianhydride with a diamine compound represented by Formula 4: 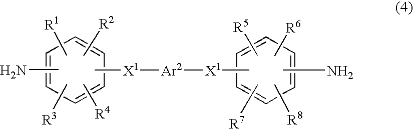
(in Formula 4, the symbols have the same meaning as in Formula 1).

7. An electrolyte composition according to claim 6, wherein the diamine compound represented by Formula 4 is a compound represented by Formula 5:

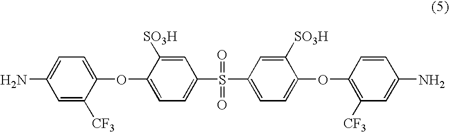

8. An electrolyte composition according to claim 2, wherein the structural unit represented by Formula 3 is obtained by a reaction of 1,4,5,8-naphthalenetetracarboxylic dianhydride with a diamine compound with no sulfonic acid groups, and having an aromatic ring which may be heterocyclic.

9. An electrolyte composition according to claim 1, wherein the number average molecular weight Mn of said sulfonic acid group-containing polyimide is in the range of 5,000 to 10,000,000.

10. A solid electrolyte membrane comprising an electrolyte composition according to any of claims 1 through 9.

11. A solid polymer fuel cell using a solid electrolyte membrane according to claim 10.

12. A method for manufacturing a solid electrolyte membrane wherein an electrolyte composition according to any of claims 1 through 9 comprises an organic solvent, the electrolyte composition containing said organic solvent is applied to a substrate, and the solvent is then removed.

13. A solid polymer fuel cell using a solid electrolyte membrane prepared according to the method of claim 12.
